(19) United States
(12) Patent Application Publication
(10) Pub. No.: US 2014/0179376 A1
(43) Pub. Date: Jun. 26, 2014

(54) PROTECTION CASE FOR MOBILE PHONE AND MOBILE APPARATUS

(71) Applicants: HON HAI PRECISION INDUSTRY CO., LTD., New Taipei (TW); HONG FU JIN PRECISION INDUSTRY (WuHan) CO., LTD., Wuhan (CN)

(72) Inventors: MIN YANG, Wuhan (CN); JIAN-HUNG HUNG, New Taipei (TW); XIN-SHU WANG, Wuhan (CN)

(73) Assignees: HON HAI PRECISION INDUSTRY CO., LTD., New Taipei (TW); HONG FU JIN PRECISION INDUSTRY (WUHAN) CO., LTD., Wuhan (CN)

(21) Appl. No.: 14/085,802

(22) Filed: Nov. 21, 2013

(30) Foreign Application Priority Data
Dec. 24, 2012 (CN) 201210565005X

(51) Int. Cl. H04B 1/38

(52) U.S. Cl. CPC H04B 1/3888
USPC 455/566; 455/575.8

(57) ABSTRACT

A mobile phone protection case for receiving a mobile phone having an audio output interface to protect the mobile phone from being scratched is provided with the present disclosure. The protection case includes a display screen, an audio signal receiver, and a display control unit. The audio signal receiver is configured to receive an audio signal carrying ID information in relation to a call or both ID information and content of a short message transmitted from the audio output interface of the mobile phone. The display control unit is configured to generate a video signal according to the received audio signal and control the display screen to display the ID information of a call or the ID information and the content of the short message to user of the mobile phone.

A mobile apparatus is also provided by the present disclosure.

### BACKGROUND

1. Technical Field

The present disclosure relates to a protection case for mobile phone and a mobile apparatus.

2. Description of Related Art

Mobile phones are generally received in protection cases to prevent the mobile phones from being scratched. However, there is a need to add other functions to the protection case to enrich the usefulness.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is a schematic view of a mobile phone protection case and a mobile phone, in accordance with an exemplary embodiment of the present disclosure.

FIG. 2 is a block diagram of the mobile phone protection case and the mobile phone in FIG. 1.

FIG. 3 is a schematic view of the mobile phone protection case displaying information in accordance an exemplary embodiment of the present disclosure.

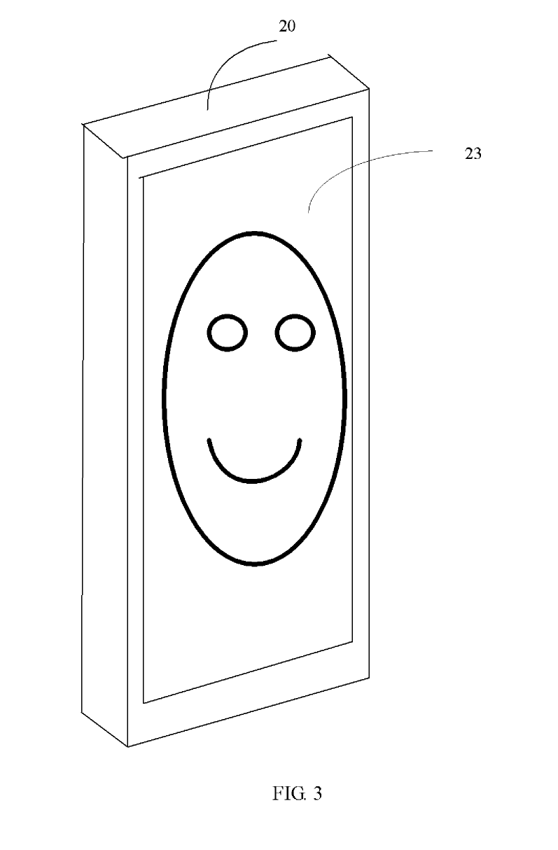

### DETAILED DESCRIPTION

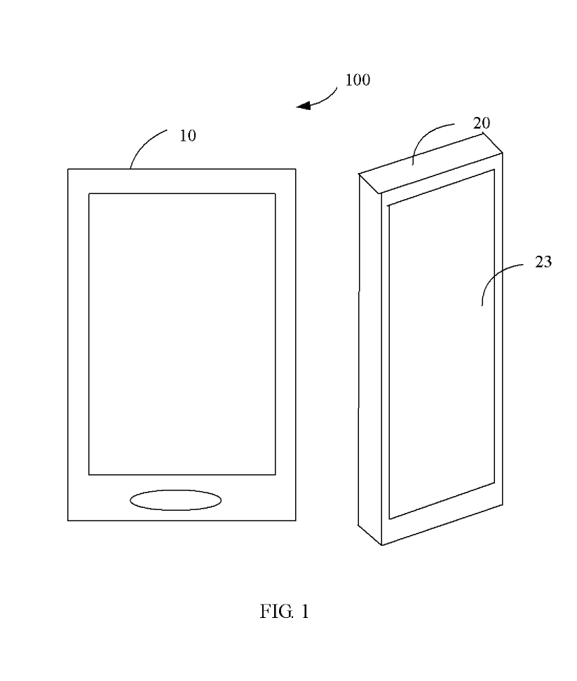

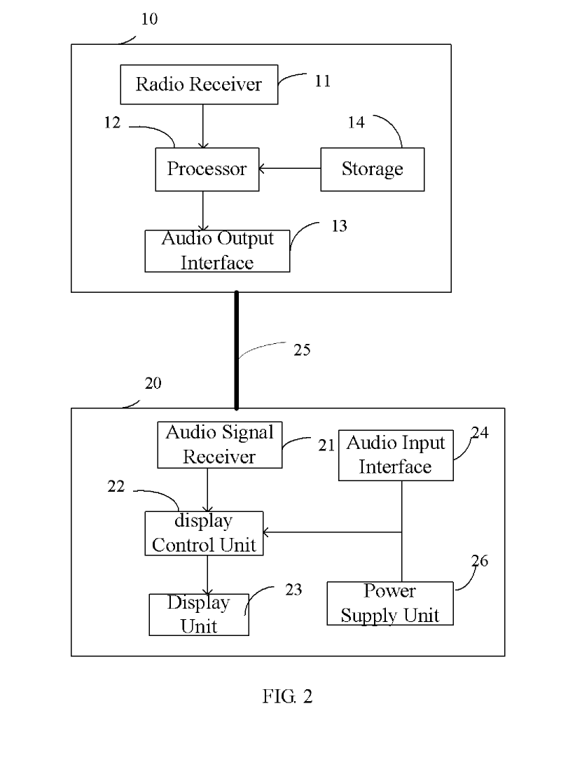

FIGS. 1-2 show a mobile apparatus 100 in accordance with an exemplary embodiment. The apparatus 100 includes a mobile phone 10 and a protection case 20 for encasing the mobile phone 10.

The mobile phone 10 includes a radio receiver 11, a processor 12, an audio output interface 13 and a storage 14. The storage 14 stores a telephone directory. The telephone directory includes a number of contact members. Each contact member is represented by at least one item selected from the group consisting of a name, a telephone number, and a picture such as portrait of the contact member. When the mobile phone 10 receives a call or a piece of short message from any of the contact members, the mobile phone 10 displays his or her name, or telephone number, or picture, which all are referred as “ID information”.

The radio receiver 11 is configured to receive radio waves from the telephone network stations when there is communication information that should be transmitted to the mobile phone 10 from the telephone network stations and generate a signal corresponding to the received radio waves. The communication information may be calls and short messages, for example, and includes the ID information of a contact member who sends the short message or makes the call.

The processor 12 is configured to obtain the ID information in relation to the call or short message according to the telephone number of the call or short message and generate an audio signal corresponding to the ID information, and transmit the audio signal to the mobile phone protection case 20 by the audio output interface 13. In the embodiment, if the communication information is a call and the storage 14 already stores the ID information of the contact member, the processor 12 transmits the ID information to the protection case 20 by the audio output interface 13; if the storage 14 does not store the ID information of the contact member, the processor 12 transmits the contact member's telephone number to the protection case 20 by the audio output interface 13. If the communication information is a short message, the processor 12 also transmits the content of the short message to the protection case 20 by the audio output interface 13.

The mobile phone protection case 20 includes an audio signal receiver 21, a display control unit 22 and a display unit 23. The display unit 23 is mounted on the outer side of the case 20 to display the ID information and the communication information. A user can obtain the communication information and the ID information through the display unit 23 without taking the mobile phone 10 out of the protection case 20. In the embodiment, the display unit 23 is a light emitting diode (LED) screen or a liquid crystal display (LCD) screen. The audio signal receiver 21 is configured to receive the wireless audio signal transmitted from the mobile phone 10. The audio signal carries the ID information in relation to a call or both ID information and the content of a short message. The display control unit 22 is configured to generate a video signal according to the audio signal, the video signal carries the ID information of the call or carries both the ID information and the content of the short message and controls the display unit 23 to display the ID information or further the content of the short message to user of the mobile phone 10.

In an alternative embodiment, the mobile phone protection case 20 includes an audio input interface 24 and an audio signal cable 25. The audio signal in relation to ID information or a short message including ID information is transferred from the mobile phone 10 to the mobile phone protection case 20 by the audio signal cable 25. In this case, one terminal of the audio signal cable 25 is connected with the audio input interface 24 of the protection case 20 and another terminal is connected with the audio output interface 13 of the mobile phone 10. In other words, when the mobile phone 10 receives a call, the ID information in relation to the call is transferred from the mobile phone 10 to the protection case 20 by the audio signal cable 25 when the audio signal cable 25 is connected with the audio output interface 13 and the audio input interface 24. The display control unit 22 is configured to control the display unit 23 to display the ID information and communication information corresponding to the audio signal transferred from the audio signal cable 25.

The case 20 further includes a power supply unit 26 to supply power for all power-driven elements of the case 20 such as the display unit 23 and the display control unit 22.

The protection case provided by the present disclosure has a display screen and can display ID information and communication information of incoming calls and short messages on the display screen. Therefore, user can obtain the caller and the communication information from the protection case without needing to remove the mobile phone from the protection case.

Although the present disclosure has been described in considerable detail with reference to certain preferred embodiments thereof, the disclosure is not for limiting the scope of the disclosure. Persons having ordinary skill in the art may make various modifications and changes without departing from the scope and spirit of the disclosure. Therefore, the scope of the appended claims should not be limited to the description of the preferred embodiments described above.

What is claimed is:

1. A mobile phone protection case, for receiving a mobile phone with an audio output interface to protect the mobile phone from being scratched, comprising:
a display unit;
an audio signal receiver configured to receive an audio signal carrying ID information in relation to a call or both ID information and content of a short message wirelessly transmitted from the audio output interface of the mobile phone;
a display control unit configured to generate a video signal according to the received audio signal and control the display screen to display the ID information of the call or the ID information and the content of the short message to user of the mobile phone.

2. The mobile phone protection case as described in claim 1, wherein the ID information comprises at least one item selected from the group consisting of a name, a telephone number, and a picture representing the contact member who makes the call or sends the short message to the user of mobile phone.

3. The mobile phone protection case as described in claim 1, wherein the picture is a portrait of the contact member.

4. The mobile phone protection case as described in claim 1, wherein the protection case comprises a power unit to supply power to the display screen and the display control unit.

5. The mobile phone protection case as described in claim 1, wherein the protection case comprises an audio signal cable and an audio input interface, one terminal of the audio signal cable is electrically connected with the audio input interface and another terminal of the audio signal cable is connected with an audio output interface of the mobile phone to transfer the audio signal corresponding to the ID information or an short message, the audio signal receiver receives the audio signal from the audio input interface.

6. A mobile apparatus, comprising:
a mobile phone; and
a mobile phone protection case encasing the mobile phone to protect the mobile phone from being scratched,
wherein:
the mobile phone comprising:
an audio output interface;
a radio receiver configured to receive radio waves in response to a call or a short message from the telephone network stations and generate a signal corresponding to the received radio waves;
a processor configured to obtain the ID information in relation to the call or the short message according to the telephone number of the call or short message and generate an audio signal corresponding to the ID information and transmit the audio signal to the mobile phone protection case by the audio output interface;
the mobile phone protection case comprising:
a display screen;
an audio signal receiver configured to receive the audio signal carrying the ID information in relation to the call or both the ID information and the content of a short message wirelessly transmitted from the audio output interface of the mobile phone;
a display control unit configured to generate a video signal according to the received audio signal and control the display screen to display the ID information of the call or the ID information and the content of the text message to user of the mobile phone.

7. The mobile apparatus as described in claim 6, wherein the mobile phone comprises a storage storing a telephone directory consisting of a plurality of contact members and ID information representing each of contact members.

8. The mobile apparatus as described in claim 7, wherein the ID information comprises at least one item selected from the group consisting of a name, a telephone number, and a picture representing the contract member who makes the call or sends the short message to the user of mobile phone.

9. The mobile apparatus as described in claim 8, wherein the picture is a portrait of the contact member.

10. The mobile apparatus as described in claim 6, wherein the protection case comprises a power unit to supply power to the display screen and the display control unit.

11. The mobile apparatus as described in claim 6, wherein the protection case further comprises an audio signal cable and an audio input interface, one terminal of the audio signal cable is connected with the audio input interface and another terminal of the audio signal cable is connected with an audio output interface of the mobile phone to transfer the audio signal corresponding to the ID information or both the ID information and the content of the short message, the audio signal receiver receives the audio signal from the audio input interface.
